(19) United States
(12) Patent Application Publication
(10) Pub. No.: US 2012/0262013 A1
(43) Pub. Date: Oct. 18, 2012

(54) Electric Machine Module Cooling System and Method

(75) Inventors: Bradley D. Chamberlin, Pendleton, IN (US); James Ramey, Fortville, IN (US); Alex S. Creviston, Muncie, IN (US)

(73) Assignee: Remy Technologies, LLC, Pendleton, IN (US)

(21) Appl. No.: 13/085,321

(22) Filed: Apr. 12, 2011

(51) Int. Cl. H02K 5/20; H02K 15/00

(52) U.S. Cl. 310/65; 29/596

(57) ABSTRACT

Embodiments of the invention provide an electric machine module. The module can include a module housing, which can comprise a sleeve member. In some embodiments, the sleeve member can include an inner wall and an outer wall, and the module housing can at least partially define a machine cavity. In some embodiments, a coolant jacket can be positioned substantially between a portion of the inner wall and a portion of the outer wall. Also, in some embodiments, at least one boss can be positioned in the sleeve member so that the at least one boss can be substantially integral with both the inner wall and the outer wall, and can extend through a portion of the coolant jacket.

### BACKGROUND

Electric machines, often contained within a machine cavity of a housing, generally include a stator and a rotor. For some electric machines, the stator can be secured to the housing different coupling techniques to generally secure the electric machine within the housing. During operation of electric machines, a considerable amount of heat energy can by generated by both the stator and the rotor, as well as other components of the electric machine. For some electric machines, the increase in heat energy can, at least partially, interfere with the coupling of the housing to the stator.

### SUMMARY

Some embodiments of the invention provide an electric machine module. The module can include a module housing, which can comprise a sleeve member and at least one end cap. In some embodiments, the sleeve member can include an inner wall and an outer wall, and the module housing can at least partially define a machine cavity. In some embodiments, a coolant jacket can be positioned substantially between a portion of the inner wall and a portion of the outer wall. Also, in some embodiments, at least one boss can be positioned in the sleeve member so that the at least one boss can be substantially integral with the inner wall and the outer wall, and can extend through a portion of the coolant jacket.

Some embodiments of the invention provide an electric machine module. The module can include a module housing, which can comprise a sleeve member and at least one end cap. In some embodiments, the sleeve member can include an inner wall and an outer wall, and the module housing can at least partially define a machine cavity. In some embodiments, a coolant jacket can be positioned substantially between a portion of the inner wall and a portion of the outer wall. Also, in some embodiments, at least one boss can be positioned in the sleeve member so that the at least one boss can be substantially integral with the inner wall and the outer wall. In some embodiments, the boss can include a channel extending a radial length of the boss and through both of the inner wall and the outer wall. In some embodiments, an electric machine can comprise a stator assembly including a plurality of stator laminations, and at least a portion of the plurality of stator laminations can include at least one feature. In some embodiments, the electric machine can be at least partially enclosed within the module housing so that the at least one feature is in fluid communication with the channel.

### DESCRIPTION OF THE DRAWINGS

FIG. 1 is a cross-sectional view of an electric machine module according to one embodiment of the invention.

FIG. 2 is a partial perspective view of a stator assembly according to one embodiment of the invention.

FIG. 3 is a partial cross-sectional view of a sleeve member according to one embodiment of the invention.

FIG. 4 is a partial cross-sectional view of portions of an electric machine module according to one embodiment of the invention.

FIG. 5 is a partial cross-sectional view of a sleeve member according to one embodiment of the invention.

FIG. 6 is a partial cross-sectional view of portions of an electric machine module, including threaded members, according to one embodiment of the invention.

FIG. 7 is a partial cross-sectional view of portions of an electric machine module according to one embodiment of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives that fall within the scope of embodiments of the invention.

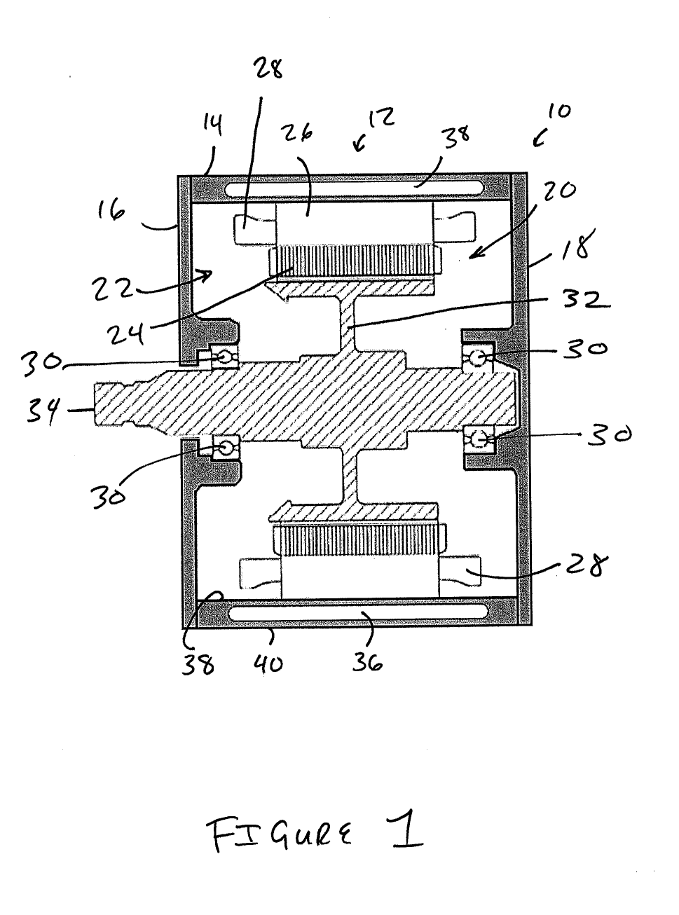

FIG. 1 illustrates an electric machine module 10 according to one embodiment of the invention. The module 10 can include a module housing 12 comprising a sleeve member 14, a first end cap 16, and a second end cap 18. An electric machine 20 can be housed within a machine cavity 22 at least partially defined by the sleeve member 14 and the end caps 16, 18. For example, the sleeve member 14 and the end caps 16, 18 can be coupled via conventional fasteners (not shown), or another suitable coupling method, to enclose at least a portion of the electric machine 20 within the machine cavity 22. In some embodiments the housing 12 can comprise a substantially cylindrical canister and a single end cap (not shown). Further, in some embodiments, the module housing 12, including the sleeve member 14 and the end caps 16, 18, can be fabricated from materials that can generally include thermally conductive properties, such as, but not limited to aluminum or other metals and materials capable of generally withstanding operating temperatures of the electric machine. In some embodiments, the housing 12 can be fabricated using different methods including casting, molding, extruding, and other similar manufacturing methods.

The electric machine 20 can include a rotor 24, a stator assembly 26, including stator end turns 28, and bearings 30, and can be disposed about an output shaft 34. As shown in FIG. 1, the stator 26 can substantially circumscribe the rotor 24. In some embodiments, the electric machine 20 can also include a rotor hub 32 or can have a “hub-less” design (not shown).

In some embodiments, the electric machine 20 can be operatively coupled to the module housing 12. For example, the electric machine 20 can be fit within the module housing 12. In some embodiments, the electric machine 20 can be fit within the module housing 12 using an interference fit, a press fit, a shrink fit, other similar friction-based fit that can at least partially operatively couple the machine 20 and the housing 12. For example, in some embodiments, the stator assembly 26 can be shrunk fit into the module housing 12. Further, in some embodiments, the fit can at least partially secure the stator assembly 26, and as a result, the electric machine 20, in both axial and circumferential directions. In some embodiments, during operation of the electric machine 20 the fit between the stator assembly 26 and the module housing 12 can at least partially serve to transfer torque from the stator assembly 26 to the module housing 12. In some embodiments, the fit can result in a generally greater amount of torque retained by the module 10.

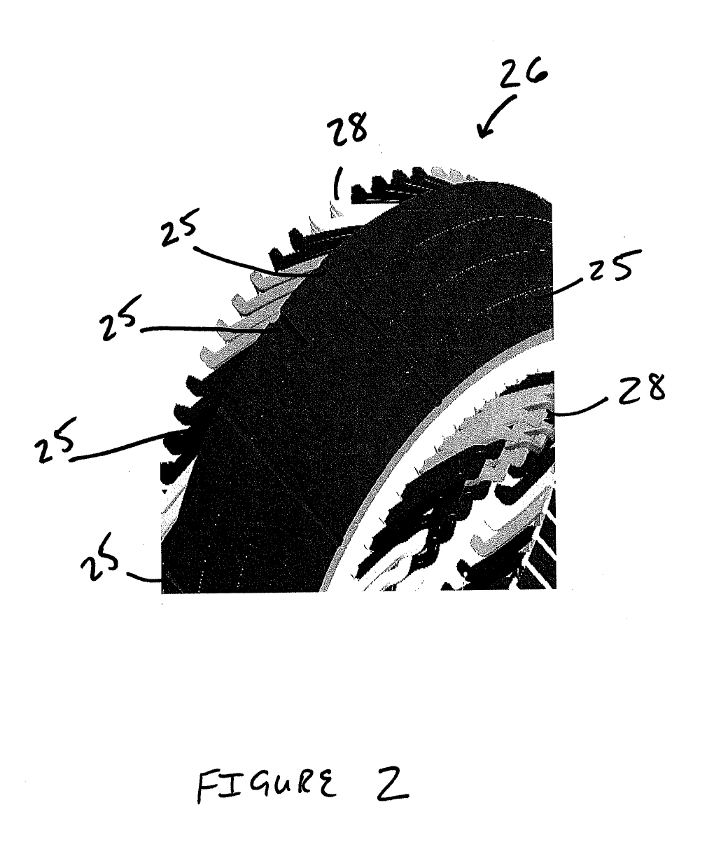

In some embodiments, as discussed in more detail below, the stator assembly 26 can comprise a feature 25 that can at least partially aid in operatively coupling together the electric machine 20 and the housing 12, as shown in FIG. 2. For example, in some embodiments, the stator assembly 26 can comprise a plurality of stator laminations (not shown) and at least a portion of the plurality of stator laminations can include a portion of the feature 25. The plurality of stator laminations can be assembled so that the portions of the feature 25 can substantially align to form the feature 25. In some embodiments, the plurality of stator laminations can be substantially assembled and then the feature 25 can be fabricated from the stator assembly 26. For example, in some embodiments, after assembly of the stator assembly 26, the feature 25 can be milled or machined into an outer diameter of the stator assembly 26. In some embodiments, the feature 25 can comprise different configurations to accommodate manufacturer and/or end user requirements.

The electric machine 20 can be, without limitation, an electric motor, such as a hybrid electric motor, an electric generator, or a vehicle alternator. In one embodiment, the electric machine 20 can be a High Voltage Hairpin (HVH) electric motor or an interior permanent magnet electric motor for hybrid vehicle applications.

Components of the electric machine 20 such as, but not limited to, the rotor 24, the stator assembly 26, and the stator end turns 28 can generate heat during operation of the electric machine 20. These components can be cooled to increase the performance and the lifespan of the electric machine 20.

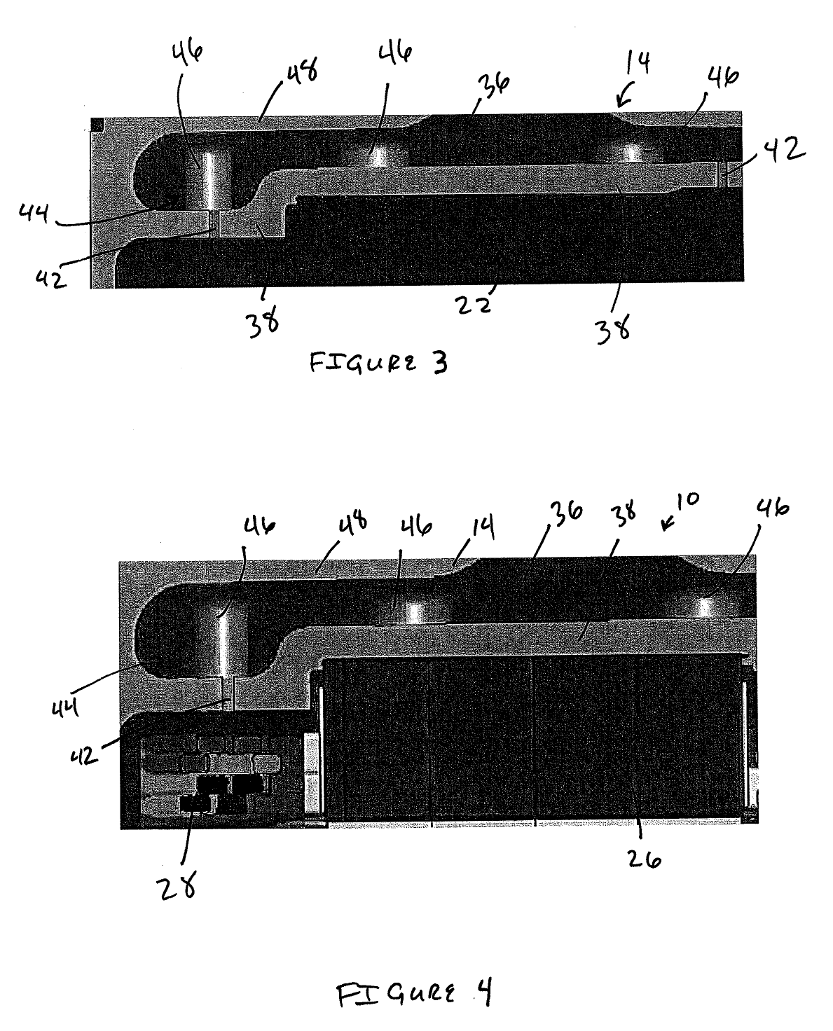

As shown in FIGS. 1 and 3, in some embodiments, the sleeve member 14 can comprise a coolant jacket 36. For example, in some embodiments, the sleeve member 14 can include an inner wall 38 and an outer wall 40 and the coolant jacket 36 can be positioned substantially between the walls 38, 40. In some embodiments, the coolant jacket 36 can substantially circumscribe at least a portion of the electric machine 20. More specifically, in some embodiments, the coolant jacket 36 can substantially circumscribe at least a portion of an outer diameter of the stator assembly 26, including the stator end turns 28.

Further, in some embodiments, the coolant jacket 36 can contain a coolant that can comprise transmission fluid, ethylene glycol, an ethylene glycol/water mixture, water, oil, motor oil, or a similar substance. The coolant jacket 36 can be in fluid communication with a coolant source (not shown) which can pressurize the coolant prior to or as it is being dispersed into the coolant jacket 36, so that the pressurized coolant can circulate through the coolant jacket 36.

Also, in some embodiments, the inner wall 38 can include coolant apertures 42 so that the coolant jacket 36 can be in fluid communication with the machine cavity 22. In some embodiments, the coolant apertures 42 can be positioned substantially adjacent to the stator end turns 28. For example, in some embodiments, as the pressurized coolant circulates through the coolant jacket 36, at least a portion of the coolant can exit the coolant jacket 36 through the coolant apertures 42 and enter the machine cavity 22. Also, in some embodiments, the coolant can contact the stator end turns 28, which can lead to at least partial cooling. After exiting the coolant apertures 42, at least a portion of the coolant can flow through the machine cavity 22 and can contact various module 10 elements, which, in some embodiments, can lead to at least partial cooling of the module 10.

According to some embodiments of the invention, the coolant jacket 36 can include multiple configurations. In some embodiments, at least a portion of the coolant jacket 36 can extend through the sleeve member 14 a distance substantially similar to an axial length of the stator assembly 26. For example, in some embodiments, an axial length of a portion of the coolant jacket 36 can extend at least the same distance as the axial length of the stator assembly 26, including the stator end turns 28. In some embodiments, portions of the coolant jacket 36 can extend greater and lesser axial distances, as desired by manufacturers and/or end users for cooling.

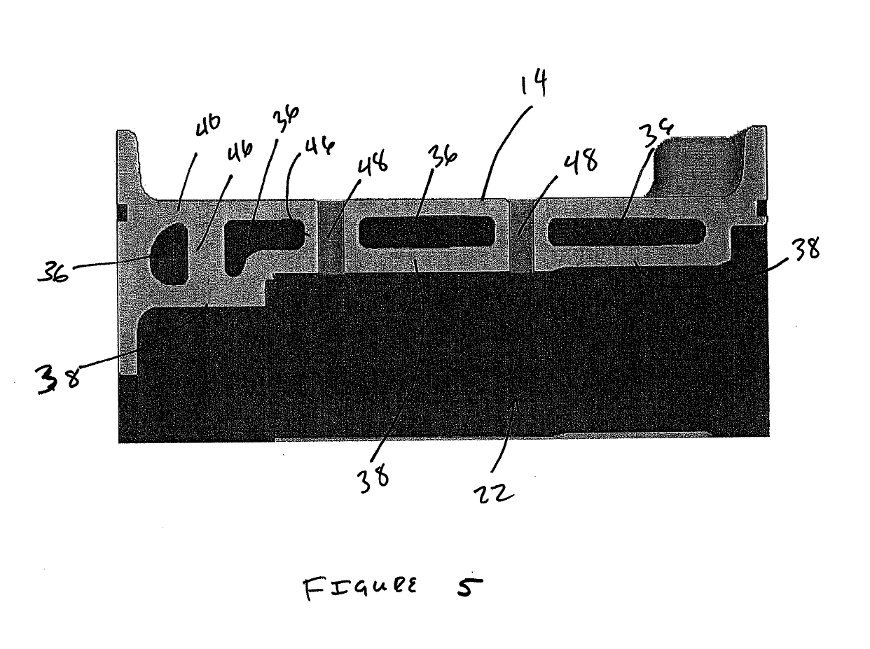

In some embodiments, a portion of the coolant jacket 36 also can comprise at least one radially inward extension 44. For example, as shown in FIGS. 3 and 4, in some embodiments, a region of the inner wall 38 can be substantially radially recessed so that the radially inward extension 44 of the coolant jacket 38 can be substantially adjacent to at least one of the stator end turns 28. In some embodiments, radially inward extensions 44 can be positioned adjacent to one of (as shown in FIG. 4), both of, or neither of the stator end turns 28. Further, in some embodiments, the coolant jacket 36 can comprise radially inward extensions 44 substantially continuously around at least a portion of an outer diameter of at least one of the stator end turns 28 (i.e., one continuous radially inward extension around a portion of at least one of the stator end turns 28). In other embodiments, the coolant jacket 36 can comprise substantially discrete radially inward extensions 44 positioned around at least a portion of an outer diameter of at least one of the stator end turns 28.

In some embodiments, the stator end turns 28 can comprise a generally lesser outer diameter compared to the stator assembly 26, and, as a result, a greater distance can exist between the stator end turns 28 and the cooling jacket 36. In some embodiments, the radially inward extensions 44 of the coolant jacket 38 can enhance module 10 cooling because some of the coolant can circulate relatively closer to the stator end turns 28, compared to embodiments substantially lacking the radially inward extension 44. As a result, in some embodiments, a distance between the coolant and an area rejecting heat energy (i.e., the stator end turns) can be generally minimized, which can lead to generally increased heat energy transfer.

According to some embodiments of the invention, the module housing 12 can comprise at least one boss 46. For example, in some embodiments, the sleeve member 14 can comprise at least one of the bosses 46. As shown in FIG. 4, in some embodiments, the boss 46 can be positioned substantially between the inner wall 38 and the outer wall 40. In some embodiments, the boss 46 can be coupled to both the inner wall 38 and the outer wall 40 using techniques such as welding, braising, conventional fasteners, and other similar coupling techniques.

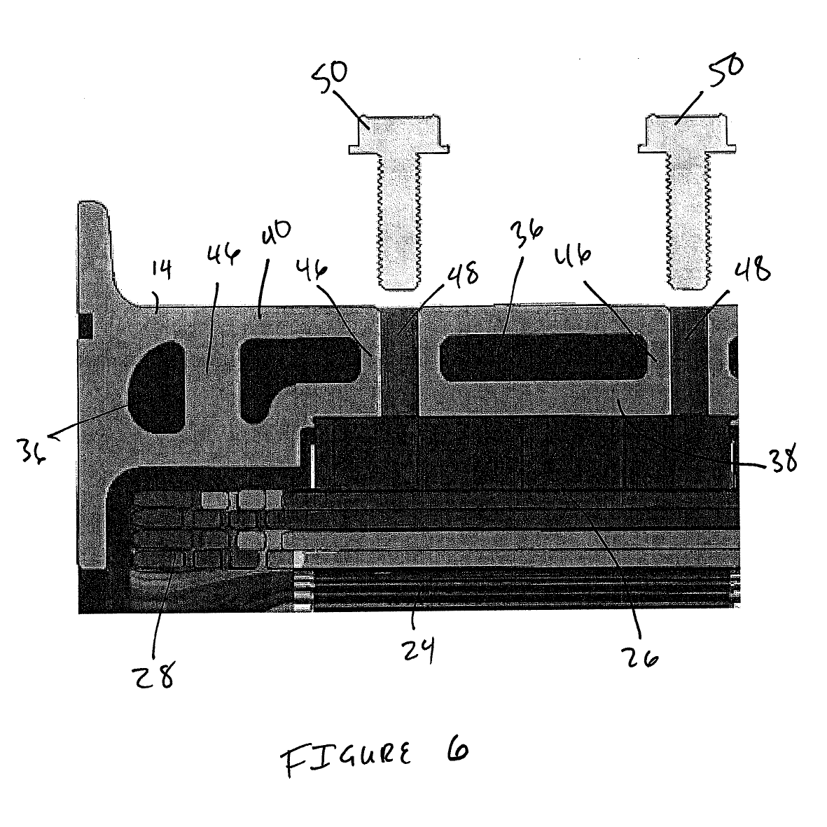

In some embodiments, the boss 46 can be formed so that it is substantially integral with sleeve member 14 (i.e., the inner wall 38 and the outer wall 40). In some embodiments, the boss 46 can be formed at substantially the same time as the sleeve member 14 so that it is integral with the inner wall 38 and the outer wall 40. By way of example only, in some embodiments, the sleeve member 14 can be manufactured via either a casting process or a similar process wherein the boss 46 can be substantially formed within the sleeve member 14 at the time of manufacture so that the boss 46 is substantially integral with the walls 38, 40 and extends through a portion of the coolant jacket 36, as shown in FIG. 5.

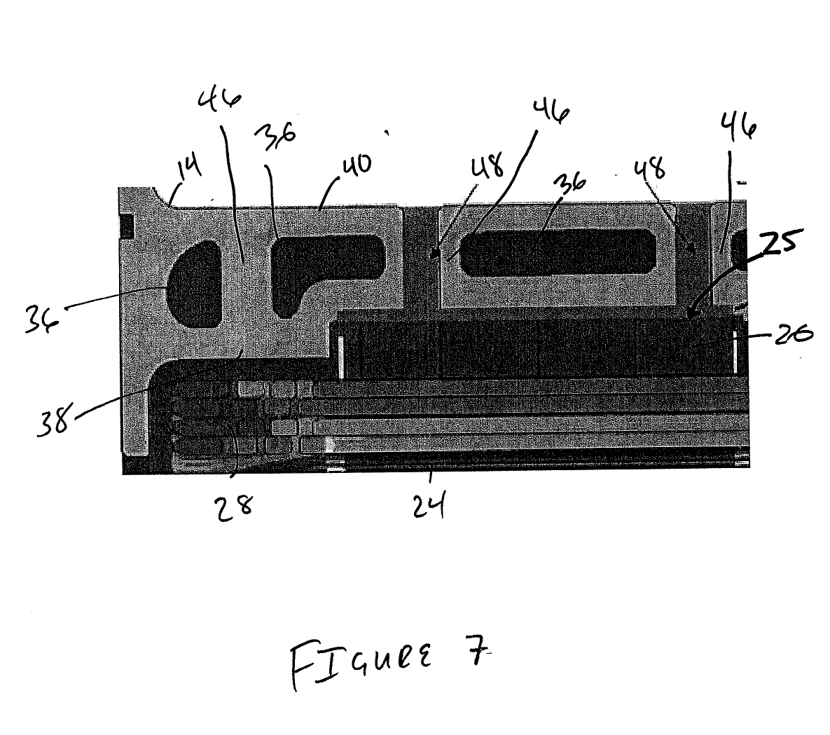

Further, in some embodiments, the housing 12 can comprise a plurality of bosses 46, as shown in FIGS. 3-7. For reference, all future references to the “boss” will be plural, however, some embodiments can comprise a single boss. For example, in some embodiments, the bosses 46 can be circumferentially positioned in the sleeve member 14 at either regular, irregular, or patterned intervals. Further, in some embodiments, the bosses 46 can be positioned substantially throughout the sleeve member 14, and in other embodiments, the bosses 46 can be positioned in portions of the sleeve member 14, as desired by the manufacturer and/or end user. In some embodiments, the bosses 46 can be positioned in the sleeve member 14 so that the bosses 46 are generally adjacent to the stator assembly 26. As shown in FIG. 6, in some embodiments, the bosses 46 can be positioned radially outward from, and adjacent to, portions of the outer diameter of the stator assembly 26 and/or the stator end turns 28. Additionally, in some embodiments, the bosses 46 can comprise a substantially cylindrical shape, and in some embodiments the bosses can comprise other shapes including square, rectangular, regular and/or irregular polygonal, and other similar shapes. In some embodiments, some of the bosses 46 can comprise different shapes. As a result, at least the size, shape, quantity, and other general characteristics can be selected based on manufacturer and/or end user needs and requirements.

Some embodiments of the invention can generally improve at least some structural aspects of the module 10. During electric machine operation, some housings comprised of a cast metal, such as aluminum, can exhibit thermal dimensional changes. For example, the cast aluminum housing of some modules can expand during operation at least partially because of the heat energy radiated by the machine. As a result, the electric machine, which, as previously mentioned, can be interference fit within the housing, can experience generally reduced torque transfer because of the loosening of the fit due to the more-rapid expansion of the housing compared to the rest of the module 10. Further, some modules can include cooling jackets which can axially extend an axial length of the stator assembly. As a result, in some modules, the axially longer the stator assembly is, the axially longer the cooling jacket could be. As a result, the structural strength of the walls surrounding the cooling jacket can proportionally become weaker as the stator assembly length is increased. In some embodiments, the bosses can improve structural strength by substantially acting as a support between the inner and outer walls as well as providing enhanced rigidity, which can at least partially reduce the previously mentioned thermal dimensional changes. Moreover, in some embodiments, during coupling and/or fitting of the stator assembly 26 into portions of the module housing 12, the bosses 46 can at least partially improve the ability of the housing 12 to retain its shape (i.e., circular, cylindrical, hemispherical, etc.) during the process. More specifically, in some embodiments, the bosses 46 can at least partially provide improved structural integrity so that the module housing 12 can retain a substantially similar shape before and after fitting of the stator assembly 26 within portions of the housing 12.

Further, in some embodiments, the bosses 46 can improve module 10 cooling. In some embodiments, the bosses 46 can create turbulence within the cooling jacket 36, which can enhance heat energy transfer between the housing 12 and the coolant. Further, in some embodiments, the bosses 46 can also provide more surface area relative to embodiments lacking the bosses, which can also enhance heat energy transfer.

In some embodiments of the invention, at least some bosses 46 can include a channel 48. In some embodiments, the channel 48 can be formed during manufacture of a boss (i.e., the boss can be cast around an element which can later form the channel), or in some embodiments, the channel 48 can be later-formed, such as by removal of a portion of an internal area of the boss 46. Also, in some embodiments, one boss 46 can comprise more than one channel 48 and some bosses 46 can substantially lack a channel 46.

As shown in FIGS. 5-7, in some embodiments, the channel 48 can extend a radial length substantially equal to a radial length of the sleeve member 14, although in other embodiments, the channel 48 can extend a shorter radial length. In some embodiments, the channel 48 can extend substantially through the outer wall 40 and the inner wall 38 so the machine cavity 22 can be in fluid communication with an environment adjacent the outer wall 40. Further, in some embodiments, the channel 48 can be configured to receive a fastener. In some embodiments, relative to bosses 46 that are substantially not integral with the sleeve member 14, integral bosses 46 comprising a channel 48 can include more boss structural integrity so that as coolant flows through the coolant jacket 36, there can be less of risk of a leak through the integral boss 46.

Referring to FIG. 6, in some embodiments, at least some of the bosses 46 can comprise a tapped surface (not shown). For example, in some embodiments, a surface of the bosses immediately adjacent to the channel 48 (i.e., the surfaces that can define a portion of the channel 48) can comprise tapping that can be configured to receive the fastener, such as a threaded member 50. In some embodiments, some of the bosses 46 comprise a tapped surface, and in other embodiments, either substantially all of, or substantially none of the bosses 46 can comprise a tapped surface. In some embodiments, the fastener can comprise fasteners other than threaded members, including non-threaded fasteners such as nails, tacks, stakes, etc.

In some embodiments, the threaded member 50 and/or other fasteners can at least partially aid in securing components of the module 10. For example, in some embodiments, the threaded member 50 can interact with the tapping of the channel 48. The threaded member 50 then can be threaded through the channel 48 to contact the stator assembly 26. In some embodiments, the feature 25 can include a configuration so that it can receive a portion of the threaded member 50 and/or other fastener. For example, in some embodiments, the feature 25 can comprise a cavity including tapped surfaces to receive a portion of the threaded member 50. In some embodiments, contact between the threaded member 50 and the stator assembly 26 can provide another physical connection and, as a result, can improve securing the stator assembly 26 to the housing 12.

According to some embodiments of the invention, as shown in FIG. 7, a coupling material can be used to enhance operatively coupling the housing 12 to the electric machine 20. In some embodiments, a coupling material, including an injection mold material, an epoxy, or other similar material can be introduced through the channel 48 so that it can flow through the channel 48 and can be directed toward the stator assembly 26. In some embodiments, the coupling material can substantially contact the stator assembly 26 after flowing through the channel 48 and can bind to or otherwise attach to the stator assembly 26, which can lead to improved coupling between the elements. In some embodiments, the introduction of the coupling material can at least partially improve the torque transfer and torque retention as previously mentioned, at least partially because of the improved coupling.

In some embodiments, the feature 25 can comprise configurations to enhance the ability of the coupling material to operatively couple together the housing 12 and the stator assembly 26. In some embodiments, the feature 25 can comprise an elongated cavity formed on the outer diameter of the stator assembly 26. More specifically, in some embodiments, the feature 25 can comprise one or more grooves positioned substantially parallel to the output shaft 34. In some embodiments, the groove can extend substantially the axial length of the stator assembly 26, and in other embodiments, the groove can extend a distance shorter than the axial length of the stator assembly 26. In some embodiments, as previously mentioned, like other feature 25 configurations, the groove can be substantially formed during assembly of the stator assembly 26 (i.e., some of the stator laminations include portions of the groove so that when aligned during assembly, the groove can be substantially formed) or after assembly (i.e., the groove can be machine, milled, or otherwise added to the stator assembly 26). Further, in some embodiments, a radially inner portion of the groove (i.e., the bottom of the groove) can comprise different shapes such as a “v,” semi-circular, square, rectangular, regular or irregular polygonal, and other similar shapes. Finally, in some embodiments, a plurality of features 25, including grooves, can be positioned around the outer diameter of the stator assembly 26 in either regular or irregular patterns.

In some embodiments, the stator assembly 26 can be positioned within the housing 12 so that at least one feature 25 can be in fluid communication with the channel 48. As shown in FIG. 7, in some embodiments, the feature 25 can be positioned substantially radially inward from the channel 48 so that the two elements can be in fluid communication. Also, in some embodiments, the stator assembly 26 can be positioned adjacent to the housing 12 so that the channel 48 is substantially in fluid communication with generally only the feature 25 and the remainder of the machine cavity 22 can be substantially sealed so that no material amounts of coupling material flow from the feature 25. Further, in some embodiments, after introduction of the coupling material through the channel 48, at least a portion of the coupling material can flow into the feature 25. More specifically, in some embodiments, the feature 25 can substantially function as an increased surface area and volume element so that an increased volume of the coupling material can reach, contact, and bind to the stator assembly 26, which can enhance operative coupling of the stator assembly 26 to the housing 12. In some embodiments, the feature 25 can be in fluid communication with other elements of the module 10 so that after introduction of the coupling material through the channel 48, at least a portion of the coupling material can efflux from the feature 25 and flow to another portion of the module 10.

In some embodiments, the sleeve member 14 and the electric machine 20 can comprise a coupling material path, as shown in FIG. 7. In some embodiments, the sleeve member 14 can comprise at least two bosses 46 positioned a distance apart, and the bosses 46 can each include a channel 48. Further, in some embodiments, a portion of the stator assembly 26 positioned adjacent to the bosses 48 can include at least one feature 25, such as, but not limited to a groove. The groove can be in fluid communication with at least two of the bosses 46, so that in some embodiments, a first boss can substantially function as a coupling material inlet and a second boss can substantially function as a coupling material outlet. As a result, in some embodiments, the coupling material can be introduced through a first boss 46 and can flow though the channel 48 and into the feature 25, as previously mentioned. Further, the coupling material circulate through the feature 25. And, as previously mentioned, in some embodiments, the feature 25 can be substantially sealed from the remainder of the electric machine 20 and the machine cavity 22. As a result, in some embodiments, a portion of the coupling material can substantially flow through the feature 25 and can exit the module 10 through a second boss 46. In some embodiments, this flow path can further enhance the interface between the stator assembly 26 and the housing 12 because a user can determine when the channels 48 and/or the feature 25 have received a maximum volume of coupling material.

In some embodiments, an end user and/or manufacturer can employ different combinations of some the previously mentioned embodiments. For example, in some embodiments, at least one boss 46 can include a channel 48 comprising a tapped surface and another boss 46 including a channel 48 so that both at least one threaded member 50 and coupling material can be used to improve operatively coupling the stator assembly 26 to the housing 12.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. An electric machine module comprising:
a module housing comprising a sleeve member, the sleeve member including an inner wall and an outer wall, the module housing at least partially defining a machine cavity;
a coolant jacket positioned substantially between a portion of the inner wall and a portion of the outer wall; and
at least one boss positioned in the sleeve member so that the at least one boss is substantially integral with both of the inner wall and the outer wall, and substantially extends through a portion of the coolant jacket.

2. The electric machine module of claim 1, wherein portions of the module housing comprise cast metal.

3. The electric machine module of claim 1, and further comprising an electric machine at least partially enclosed within the module housing, the electric machine including a stator assembly, the stator assembly comprising stator end turns and positioned so that the coolant jacket substantially circumscribes a portion of the stator assembly.

4. The electric machine module of claim 3, wherein the at least one boss is positioned in the sleeve member radially outward from a portion of the stator assembly.

5. The electric machine module of claim 4, wherein the at least one boss comprises a channel through a portion of the boss, the channel sized and dimensioned to receive a fastener.

6. The electric machine module of claim 5, wherein the at least one boss comprises a tapped surface immediately adjacent the channel, the tapped surface configured to receive a portion of the fastener.

7. The electric machine module of claim 6, wherein the stator assembly comprises at least one feature configured to receive a portion of the fastener, the at least one feature positioned on the stator assembly so that the at least one feature is immediately adjacent the at least one boss.

8. The electric machine module of claim 3, wherein an axial length of a portion of the coolant jacket is at least substantially equal to an axial length of the stator assembly.

9. The electric machine module of claim 3, wherein the coolant jacket comprises at least one radially inward extension adjacent at least one of the stator end turns.

10. An electric machine module comprising:
a module housing comprising a sleeve member, the sleeve member including a coolant jacket, the module housing at least partially defining a machine cavity;
at least one boss positioned in the sleeve member so that the at least one boss is substantially integral with the sleeve member and extends through a portion of the coolant jacket, the at least one boss including a channel extending a radial length of the at least one boss and through a portion of the sleeve member; and
an electric machine comprising a stator assembly, the stator assembly including a plurality of stator laminations, at least a portion of the plurality of stator laminations including at least one feature, the electric machine at least partially enclosed within the module housing so that the at least one feature is in fluid communication with the channel.

11. The electric machine module of claim 10, wherein the stator assembly further comprises stator end turns; and
the coolant jacket comprises at least one radially inward extension adjacent at least one of the stator end turns.

12. The electric machine module of claim 10, wherein the channel and the at least one feature are configured and dimensioned to at least partially operatively couple a portion of the electric machine to a portion of the module housing.

13. The electric machine module of claim 10, wherein a portion of the module housing comprises cast metal.

14. The electric machine module of claim 13, wherein the sleeve member comprises a plurality of bosses.

15. The electric machine module of claim 10, and further comprising coolant apertures positioned through a portion of an inner wall of the sleeve member so that the coolant jacket is in fluid communication with the machine cavity.

16. The electric machine module of claim 10, wherein the at least one boss comprises a tapped surface immediately adjacent the channel.

17. A method of manufacturing an electric machine module, the method comprising:
providing a module housing, the module housing comprising a sleeve member and at least one end cap, the sleeve member including a coolant jacket;
positioning at least one boss within the sleeve member so that the at least one boss is substantially integral with the sleeve member, and extends through a portion of the coolant jacket;
providing an electric machine including a stator assembly; and
installing at least a portion of the electric machine within the module housing so that the at least one boss is adjacent to the stator assembly.

18. The method of claim 17, wherein the at least one boss comprises a channel extending therethrough.

19. The method of claim 18, wherein the at least one boss comprises a tapped surface immediately adjacent the channel, and wherein the method further comprises inserting a threaded fastener through the channel so that the threaded fastener contacts the stator assembly.

20. The method of claim 18, wherein the stator assembly comprises at least one feature in fluid communication with the channel, and wherein the method further comprises injecting a coupling material through the channel and so that the coupling material contacts the at least one feature.
